(19) United States
(12) Patent Application Publication
(10) Pub. No.: US 2020/0410623 A1
(43) Pub. Date: Dec. 31, 2020

(54) CURBSIDE GEOFENCING AND METERING

(71) Applicant: CURBFLOW INC, Dover, DE (US)

(72) Inventor: Ali Vahabzadeh, San Francisco, CA (US)

(73) Assignee: CURBFLOW INC, Dover, DE (US)

(21) Appl. No.: 16/454,244

(22) Filed: Jun. 27, 2019

(51) Int. Cl. G06Q 50/30; G06Q 10/02; G06Q 30/02; H04W 4/021; H04W 4/029; G07B 15/02

(52) U.S. Cl. CPC G06Q 50/30; G06Q 10/02; G07B 15/02; H04W 4/022; H04W 4/029; G06Q 30/0283

(57) ABSTRACT

A method and device store a first geo-fence boundary associated with a particular curbside location inside of region of a municipality. Geo-based data are received from a mobile device of a commercial vehicle operator when within an estimated travel time of the geo-fence boundary. The device sends information associated with a plurality of available geo-fenced curbside locations to the mobile device. The device receives a selection of one of the available geo-fenced curbside locations, and, in response, the device reserves the selected curbside location for a pre-determined time. Upon completion of the transaction, a fee is charged to an account of the commercial vehicle operator based on detecting a crossing of the geo-fence boundary within a pre-determined time after receiving the selection for the reserved curbside location.

### BACKGROUND

Cities are suffering from record levels of vehicle congestion on their streets, curbs, and sidewalks due to the recent explosion of mobile phone applications that connect vehicle operators with brick-and-mortar retailers, conventional services, and new product and service providers. For example, an increased amount of pickup and delivery traffic has occurred based on a variable and ever-increasing number of ride-sharing operators picking up and dropping off passengers. On-demand product delivery services pick up and drop off everything from food to dry cleaning where previously no such delivery operators and vehicles existed. Electric scooters and rental bike fleets are further crowding street and sidewalk use throughout communities world-wide. These uses are in addition to organic population growth and urbanization.

Further, increased traffic and congestion is increasingly costing governments and businesses billions of dollars in lost productivity. As just one example, at the time of filing of this application, an additional five minute delay per day for each vehicle in operation for the United Parcel Service (UPS, a U.S. package delivery and supply chain management company), would lead to a $105 million additional annual operating cost. Merely redesigning roads, drop-off points, curbs, and sidewalks cannot alleviate the congestion and traffic.

### SUMMARY

Described herein are embodiments of mechanisms and methods for allowing businesses, property owners, and municipalities to monitor, notify, plan, toll, and incentivize improved access to existing street curbs and sidewalks. These mechanisms provide increased efficiencies in real-time among the participants. One or more various users such as a commercial vehicle operator (CVO) or a ride hailer provides pick-up, drop-off, or other use data in exchange for access to curbs, sidewalks, and other locations designated for pick-up and delivery activities. The described mechanisms empower city officials to flexibly manage and monetize urban inventory through planning, logistics, and improved communications among the various participants.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating operation of a curbside system including geofencing and metering in accordance with some embodiments.

FIG. 2 is a block diagram illustrating curbside locations and operation of a curbside system including geofencing and metering among devices in accordance with some embodiments.

FIG. 3 illustrates a sequence of user interface (UI) screens on a device participating in the curbside system in accordance with some embodiments.

FIG. 4 illustrates a block diagram of a graphical user interface for adjusting curb use fees in a municipality in accordance with some embodiments.

FIG. 5 illustrates a block diagram of a graphical user interface for a municipality user to access fee collection of a set of curb locations according to some embodiments.

FIG. 6 illustrates a block diagram of a graphical user interface for a municipality user to access previous fee collection of a set of curb locations according to other embodiments.

FIG. 7 illustrates a block diagram of a graphical user interface having a map and interactive regions for planning use of curbside locations and setting prices based on past data collected according to some embodiments.

FIG. 8 is a block diagram of a method of providing geofencing and curbside metering to participating devices in a use transaction according to some embodiments.

FIG. 9 is a block diagram of an additional method of providing geofencing and curbside metering according to some embodiments.

FIG. 10 is a block diagram of an additional method of providing geofencing and curbside metering according to some embodiments.

### DETAILED DESCRIPTION

As further described below, and as explained in relation to the figures, mechanisms and techniques provide curbside geofencing and metering with respect to pre-determined particular locations within a municipality. The municipality is the term used herein to refer to a geographic area having one or more particular curbside regions available for a use: effectively a short-term exclusive or non-exclusive rental of a location with a range of the system. The municipality refers to either an incorporated or non-incorporated governmental area.

Each municipality provides information about locations within the municipality that serve as pick-up and drop-off points for people and products and facilitate delivery of services. For convenience, the pick-ups and drop-offs are performed by actors referred to as a commercial vehicle operator (CVO). Unless indicated otherwise, geofencing and metering are performed based on a mobile device carried by a respective commercial vehicle operator or device included in the vehicle itself.

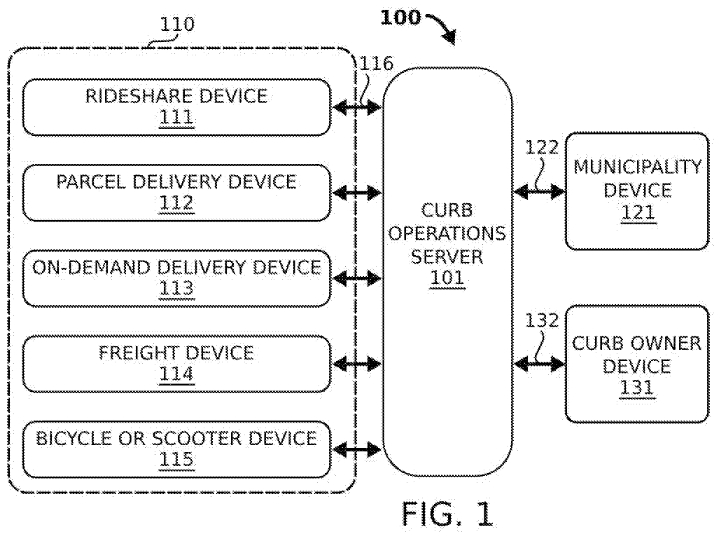

FIG. 1 is a block diagram illustrating operation of a curbside system 100 including geofencing and metering in accordance with some embodiments. The system 100 includes a curb operations server 101 that receives and sends information to other devices including: a set of devices 110 belonging to various entities such as at least one municipality device 121. In some embodiments, at least one curb owner interacts with the curbside system through a curb owner device 131. By way of example, the set of devices 110 include a rideshare device 111 of a rideshare operator, a parcel delivery device 112 of a parcel delivery provider, an on-demand delivery device 113 of an on-delivery service provider, a freight device 114 of a freight delivery service provider, and a bicycle device or scooter device 115 of a bicycle or scooter of a bicycle or scooter sharing provider. The specific devices 111-115 of the set of devices 110 are representative of types of operators that interoperate with the system 100 in terms of pick-ups and deliveries at various curbs of a municipality. The municipality is the term used herein to refer to a geographic area having one or more particular curbside regions available for a use: effectively a short-term exclusive or non-exclusive rental of a location with a range of the system 100.

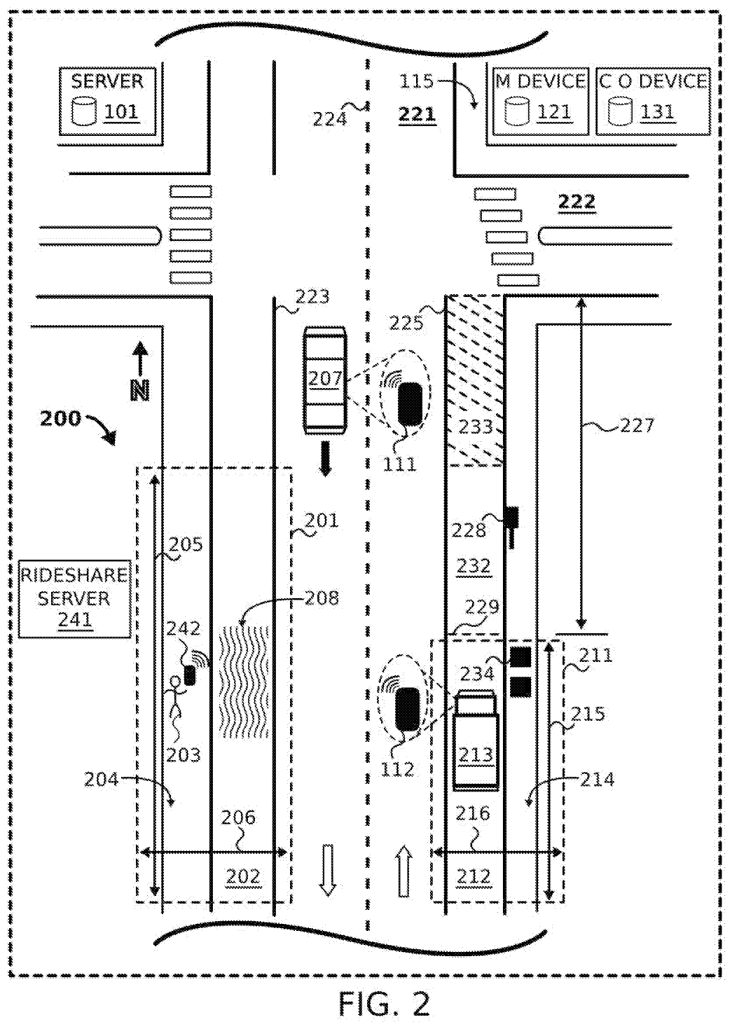

What is not shown in the system 100 is a corresponding server for each of the devices 111-115 of the set of devices 110 that enable the respective services. For example, a rideshare server (not illustrated) as understood by those in the art communicates with the rideshare device 111 of the system 100 to allow a driver to locate a rider and provide a ride to the rider. In some embodiments, the curb operations server 101 communicates with the rideshare server as further explained below in reference to FIG. 2.

In general, in the system 100, each of the devices 111-115, for example the first device 111, provides a current location and identification data to the curb operations server 101. In terms of current location, one or more location data from each device 111-115 for a particular use provides information to the server 101. For example, the current location data takes the form of an identifier associated with a particular geofenced area, a timestamp, and a device identifier for the particular device 111-115. In other embodiments, similar data or other data are provided to track the particular use or transaction with the system 100.

One or more curbside locations are provided to the system 100 and the curb operations server 101. For example, a set of geofence GPS locations or coordinates including or corresponding to a roadway adjacent to a particular curbside location are communicated as data 122 to the server 101. This data 122 is communicated from municipality device 121 to the server 101. For example, a user authorized by the municipality submits the data 122 by way of the municipality device 121 to the server 101. In other embodiments, curbside locations are provided by the curb owner device 131 as data 132, or provided by a combination of both the municipality device 121 and the curb owner device 131. In at least some embodiments, curbside locations are provided by a third party and one or more third-party devices which create location and related data. Typically, this step is a one-time step until curbside locations are re-defined such as due to a road construction altering a particular curbside location such as in the form of a change to a GPS or geo-based datum.

Next in time, upon one of the devices 111-115 initiating a use of a particular curbside location, the server 101 matches the current location of the device 111 to a designated curbside location in a municipality. The server 101 provides (i.e., charges) a base rental rate in the form of a toll for an operator of the rideshare device 111 using the designated curbside location. The rental rate is a flat fee per-use or a monetary rate per unit of time to use the designated curbside location. In at least some embodiments, depending on a current condition of the designated curbside location, the server 101 also provides a rebate for use of the particular designated curb location. For example, if the particular designated curbside location is used during an off-peak time of day, a rebate effectively lowering an overall charge for renting the particular designated curbside location for the rideshare pick-up or drop-off. The devices 111-115 thereby provide data 116 to the server 101, and the server 101 provides at least an indication or notification of the charge to a bank account or other financial account to the devices 111-115 when the devices 111-115 participate with the system 100. In some embodiments, this communication is authorized and permitted through the respective service servers (not illustrated) supporting the operation of the set of devices 110. In other embodiments, each of the devices 111-115 register with and provide an identifier to the server 101 independently of interoperating with the respective service servers supporting the devices 111-115.

In some embodiments, the server 101 also provides an identification of one or more available particular curbside locations in substantially real-time and a rate for each of the available curbside locations as part of the data 116 exchanged between each of the devices 111-115 and the server 101. The rates may be updated from one or more of the municipality device 121 and the curb owner device 131 based on one or more prevailing and real-time conditions at each particular curbside location. With reference to the bicycle device or scooter device 115, the system 100, such as through the server 101, also provides a code that activates the mobility device associated with the particular device 115 so that the mobility device is granted permission to operate for a time.

In summary, FIG. 1 illustrates the various participants (devices 101, 111-115, 121, 131) and data 116, 122, 132 in and among the system 100. The system 100 is referred to broadly as a curbflow system in which data and payments are exchanged among devices where each particular device 111-115, 121, 131 is associated with a particular participant to facilitate curbside transactions and meter use of curbs in a municipality. As understood by those in the art, the data 116, 121, 131 exchanged between the devices in the system 100 can be extensive and on-going for each transaction, or can be simple for each transaction that involves a use of a particular participating curbside location in the municipality.

FIG. 2 is a block diagram illustrating curbside locations 202, 212 and operation of a curbside system 200 including geofencing and metering among devices in accordance with some embodiments. The curbside system 200 illustrates further details of the curbside system 100 with a first curbside location 202 and a second curbside location 212 associated with a first curbside use and a second curbside use of the same, respectively. The curbside system 200 illustrates how additional interactions and additional components facilitate increased fuel efficiency, transportation, and reduced delays for participants and non-participants when scheduling use of curbside locations 202, 212 through use of the described geofencing and metering.

The system 200 illustrates a small portion of a municipality including: a first street 221 that extends north-south with two-way traffic north and south as indicated by the traffic flow arrows, and a second street 222 crossing the first street 221 at an intersection. The second street 222 supports two-way traffic traveling east-west in the system 200 where the two lanes of traffic are divided by a physical divider. The first street 221 includes at least one northbound lane separated from a southbound lane by a dashed line 224. A first solid line 223 separates the southbound travel lane from a pick-up and drop-off lane adjacent to a sidewalk 204 on a west side of the first street 221. A second solid line 225 separates the northbound travel lane from a plurality of regions 212, 232, 233 adjacent to a sidewalk 214 on an east side of the first street 221. While not illustrated in color, the first solid line 223 and the second solid line 225 would be white lines and the dashed line 224 would be a yellow line in a U.S.-based municipality. The street scene in FIG. 2 is representative of a typical land use of a municipality and serves to illustrate use of the system 200.

The system 200 includes electronic communications between two or more of the curb operations server 101 labeled SERVER, the municipality device 121 labeled “M DEVICE”, the curb owner device 131 labeled “C 0 DEVICE”, the rideshare device 111, the parcel delivery device 112, and a rideshare request device 242. The rideshare device 111 and the rideshare request device 242 are used and associated with the first curbside location 202. The parcel delivery device 112 is used and associated with the second curbside location 212.

The first curbside use is associated with a rideshare pick-up of a rideshare participant 203 carrying and interacting with the rideshare request device 242 (e.g., a smartphone) that is in electronic communication with a rideshare server 241. For sake of convenience, the rideshare server 241 is illustrated adjacent to the first curbside location 202 but would be located near or far, in or outside of the geographic region illustrated in the system 200. The same applies to the curb operations server 101, the municipality device 121, and the curb owner device 131. The rideshare server 241 is available and communicates with one or more of the rideshare device 111 and the rideshare request device 242 through cellular data traffic mechanisms as understood by those in the art. In the time illustrated in the curbside system 200, the rideshare participant 203 has requested a ride via a rideshare transaction with the rideshare server 241. In turn, the rideshare server 241 has dispatched a CVO (not illustrated) inside a rideshare vehicle 207 that is in route southbound in the first street 221.

The rideshare vehicle 207 is nearing a ride rendezvous point 208 illustrated by a shaded region adjacent a first sidewalk in the pick-up and drop-off lane marked off by the first solid line 223. The rendezvous point 208 is inside of the first curbside location 202 that is identified by a first geofence boundary 201. Data associated with this geofence boundary 201 has previously been provided to the server 101 or one or more other devices that track use of the same in this transaction. For example, this data has been provided to the system 200 and the server 101 via the municipality device 121. This first geofence boundary 201 is one of a fixed boundary or a dynamic boundary for the transaction (first use) or for the first curbside location 202. For example, the boundary 201 is one of: (1) a fixed boundary for use by a first service such as the rideshare service represented by the rideshare server 241, (2) a fixed boundary for use by all services of a set of services operative in the municipality as represented by the set of devices 110, and (3) a dynamic boundary for use in the first curbside location 202 by the particular rideshare transaction between the rideshare participant 203 and the CVO of the rideshare vehicle 207. In this example, the geofence boundary 201 is of a first length 205 and a first width 206. These dimensions 205, 206 are different from a second length 215 and a second width 216 of a second geofence boundary 211 associated with the second curbside location 212. In terms of fixed and dynamic, for example, the first geofence boundary 201 remains the same or changes over time or over one or more of the first length 205 and the first width 206, and this boundary 201 remains the same or changes within the pick-up transaction or between rideshare transactions based on demand within ridesharing as managed by the rideshare server 241 or based on demand for some or all of the first curbside location 202. By way of example, when the system 200 is aware of a low-use condition, the length 205 is of a first size larger than a second size in a high-use condition such as during a peak traffic time period on the first street 221. By resizing the first boundary 201, the entire curbside area adjacent to the first sidewalk 204 can be re-partitioned into multiple locations along this area for multiple contemporaneous uses during the peak traffic time period.

In operation, according to some embodiments and an illustrative scenario, ridesharing using the system 200 and the curb operations server 101 operates as follows. A user or participant such as the rideshare participant 203 via the rideshare request device 242 requests pick-up from the curb operations server 101. This request is first received by the rideshare server 241 and relayed from the rideshare server 241 to the server 101. Next, the server 101 assigns an available curbside space, such as the first curbside location 202 and the first boundary 201, to the rideshare server 241 which then relays geofence-based information (e.g., directions) to the rideshare request device 242. If not already within the first curbside location 201, the rideshare participant 203 proceeds to the location 201. In some embodiments, the rideshare request device 242 communicates to the rideshare server 241 that the device 242 has crossed a geofence boundary associated with the first location 202. In some embodiments, this event is also communicated to one or more of the curb operations server 101 and the rideshare device 111.

Approximately contemporaneously, the CVO matches a rider request with a vehicle (such as rideshare vehicle 207) through the rideshare server 241 and sends a communication to the rideshare device 111. By way of the rideshare server 241, the curb operations server 101 provides an identity or location information (e.g., travel directions, turn-by-turn directions, indication on a map corresponding to the first boundary 201) to the rideshare device 111 of the rideshare CVO. In other embodiments, the curb operations server 101 provides location information directly to the rideshare device 111 for this rideshare transaction.

When the rideshare device 111 crosses the first geofence boundary 201 associated with the location 202, the rideshare device 111 has a predesignated time (e.g., X minutes) to complete pick-up of the rider 203 having the rideshare request device 242. In some embodiments, when the rideshare request device 242 crosses the first geofence boundary 201 associated with the location 202, the rideshare request device 242 has a predesignated time (e.g., Y minutes) to complete the pick-up (e.g., participant 203 entering the rideshare vehicle 207) and leave the first curbside location 202.

After stopping of the vehicle 207 within the first curbside location 202, the CVO triggers through a user interface (UI) on the rideshare device 111 completion of use of the first location 202. Based on this UI interaction, data are communicated to the rideshare server 241 and relayed to the server 101, or are communicated directly with the curb operations server 101 from the rideshare device 111. In turn, the server 101 re-assigns the first curbside location 202 to a next-in-time user that is in a queue maintained by the rideshare server 241 or the curb operations server 101. The reassignment is to a second rideshare participant (not illustrated) or a second participant that is using another service such as one of the set of devices 110 and corresponding service of the set of services participating with the curb operations server 101. In some implementations, each curbside transaction is confirmed with timestamped GPS data shared by each of the participating devices 111, 242 such that both devices were present near or inside the first geofence boundary 201.

In other embodiments, reassignment is performed based on a prediction by the curb operations server 101 when the particular curb location should be vacated by the participants. For example, the server 101 provides a predetermined fixed time for the rideshare pick-up event such as a three-minute window or a six-minute window in which the rider should find the rideshare CVO and vacate the first curbside location 202.

In this example, one device such as the rideshare request device 242 or the rideshare device 111 is effectively renting the first curbside location 202 at a time. In other embodiments, multiple users can effectively use the first curbside location 202 during a same time period based on one or more factors or transaction constraints. For example, use by multiple users contemporaneously is based on a predetermined average amount of time to complete a pick-up for a rideshare transaction, the length 205 of the first curbside location 202, and an amount of time to a next rendezvous of a same or a different service of the set of services represented by the set of devices 110. In certain embodiments, the transaction with the rideshare server 241 and the server 101 continues until the rideshare server 241 or the curb operations server 101 receives a signal triggered by detection of one or both of the rideshare device 111 and the rideshare requesting device 242 having crossed out of the first geofence boundary 201 associated with the first curbside location 201 confirming that the location 201 is vacant.

Finally, based on a fixed fee or a variable fee arrangement, the rideshare transaction associated with the illustrated rideshare pick-up in the first curbside location 202 is assessed a fee. The fee is tracked and accounted for by one or more of the curb operations server 101 and the rideshare server 241. One or more of the curb owner (e.g., via the curb owner device 131) and the municipality (e.g., via the municipality device 121) associated with the first curbside location 202 eventually is provided funds based on the assessed fee for the particular rideshare transaction. For example, at the end of each day, each week, each month, or other accounting period, one or more of the curb owner and the municipality receive funds for each use of the first curbside location 202.

In this way, the first curbside location 202 is metered where previously such metering was not possible without the use of the curb operations server 101. For example, conventional metering by a municipality involves selecting locations such as a first parking stall 232 and providing a parking meter 228 adjacent to the first parking stall 232. In the event that this first parking stall 232 were empty at the time of pick-up, this stall 232 would be used for the curbside pick-up of the participant 203 without receiving any income by way of receiving funds at the parking meter 228. Further, the system 200 is able to monetize previously unmonetized curbside spaces such as a first reserved (no-park) zone 233. The system 200 is able to charge a fee to the rideshare service as represented by the rideshare server 241. In turn, the rideshare service can recoup its fee from a charge assessed to one or more of the users associated with the rideshare device 111 and the rideshare requesting device 242. Through use of the system 200, the municipality is able to monetize previously untracked curbside locations such as the first curbside location 202 and the second curbside location 212. The curb operations server 101 provides additional funds not previously possible because the rideshare pick-up can include locations not previously available for rental and does not require a human fee collector such as a parking ticket attendant who must patrol the curbside locations 202, 212, 232.

Further, the system 200 facilitates real-time monitoring of commercial activities within its boundaries via data provided by the participating devices 111, 112, 241, 242 and sent to the curbside operations server 101. The mobile devices 111, 112, 242 provide geolocation and other information about pedestrian and commercial vehicular travel within the municipality and this information or data is aggregated across multiple service providers where previously such activity was not possible.

In general, in the system 200, data are provided by certain devices 111, 112, 242 to a central processing device such as the curb operations server 101. One or more calculations and determinations are made therein. One or more notifications are sent to one or more of the devices 111, 112, 242 based on the information provided. Metering is performed based on the information processed by the server 101. Metering is one example of a financial transaction implemented between the participants, the municipality, and third-party services that are contracted to communicate with the curb operations server 101 in the system 200. With the curb operations server 101, the system 200 provides a load balancing of use of sidewalks and curbside locations such as the first and the second curbside locations 202, 212. These locations 202, 212 become part of an inventory of rentable locations. For example, for a sidewalk or a roadway under construction (e.g., southbound lane of the first street 221 and west side sidewalk 204), the server 101 can direct pedestrian and pick-up CVOs represented by the vehicle 207 to another part of the system 200 such as the east side sidewalk 214 for pick-ups. The same type of traffic monitoring and directing can be performed for certain commercial activities such as in support of a concert that is scheduled to dismiss at a certain time of day or night thereby shaping both pedestrian and vehicular traffic within the system 200. Real-time and aggregate curbside use data from each service of the set of services represented by the devices 111-115 of the set of devices 110 can be put to use for the benefit of all participants in the municipality and the system. Not only is the traffic improved and additional revenue gained by the system 200, the locations 202, 212 are made safer by reducing traffic in certain highly trafficked areas and the reduced traffic, even when reduced by a few percent, can have dramatic effect during certain times when traffic is at a maximum. City planners of the municipality are able to assess, location by location, how certain curbside locations 202, 212 are being used and can plan future uses and activities based on use data collected in the system 200. The collected data facilitates faster evaluation of use of the various locations 202, 212 and provides a productivity score based on revenue collected for use of these curbside locations 202, 212.

The second use in the second curbside location 212 further illustrates features of the system 200. The second use involves a CVO operating a parcel delivery vehicle 213 within the second curbside location 212 where the CVO carries the parcel delivery device 112. While the parcel delivery device 112 may communicate with a parcel delivery service server (not illustrated), in this example, the parcel delivery device 112 communicates directly with the curb operations server 101. The parcel delivery device 112 sends and receives information about the transaction to pick-up and transport parcels 234 currently positioned on the second sidewalk 214. Previously, the geofence boundary 211 has been provided to the curb operations server 101. A top edge of the second geofence boundary 211 is south of a painted boundary 229 associated with the first parking stall 232 and its parking meter 228. From the north, the second geofence boundary 211 is located a distance 227 from an edge of the second street 222. In some embodiments, this distance 227 is based on a location of the parcels 234 relative to a geographic feature such as the parking meter 228, the boundary 229, or a cross street such as the second street 222. Alternatively, the distance 227 is based on boundaries of adjacent curbside regions such as the first parking stall 232 and the first geofence boundary 201. The second width 216 and the second length 215 define the second geofence boundary 211 and the second curbside location 212 therein. One or more of the second width 216 and the second length 215 are identified and provided in the form of the geofence boundary 211 based on a size of the parcel delivery vehicle 213 as a larger vehicle 213 such as a semi-truck would require a longer length 215 and a larger second curbside location 212 than a small (e.g., 13 ft, 15 ft) delivery truck.

In operation, the following illustrative steps are involved with the second use. A user (not illustrated) orders pick-up of the parcels 234. A parcel delivery operator, such as via a parcel delivery server, requests a pick-up location from the curb operations server 101. The server 101 assigns to this transaction an available defined space at the curb, which is the second curbside location 212 defined by the geofence boundary 211. In some embodiments, the server 101 also assigns a start time for use of the second curbside location 212 in the future based on a then-current geolocation of the parcel delivery vehicle 213 within the system 200 and an estimated travel time for the vehicle 213 to reach the second curbside location 212.

Next, the server 101 provides directions to the parcel delivery device 112 that guide the CVO operating the vehicle 212 to the second curbside location 212. Starting from a time when the system 200 detects the parcel delivery device 112 crossing into the second geofence boundary 211, the CVO is provided a predetermined amount of time (e.g., 5 minutes, 10 minutes) to pick up the parcels 234, place the parcels 234 into the vehicle 213, and move the vehicle 213 out of the second geofence boundary 211. As understood by those in the art, a location is determined in the system 200 based on a GPS component of a respective device such as the parcel delivery device 112. In some embodiments, detection by the system 200 that the parcel delivery device 112 has exited the second geofence boundary 211 stops a timer running from a start time of the pick-up. In other embodiments, the CVO triggers the timer to stop through an interaction with a user interface (UI) operative on the parcel delivery device 112. This UI interaction and stopping of the timer completes the curbside pick-up in the second curbside location 212. Based on detecting the completion of the pick-up, the curb operations server 101 re-assigns the second curbside location 212, or a partial portion of this location 212, to a next user and a next curbside transaction. The server 101 receiving a signal from the parcel delivery device 112 confirms that the second curbside location 212 is vacant and available for a subsequent use.

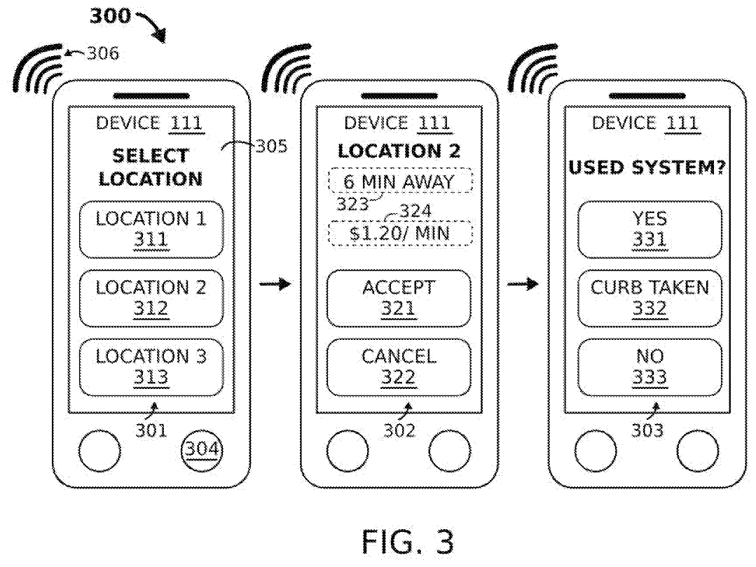

FIG. 3 illustrates a sequence 300 of user interface (UI) screens 301-303 on the rideshare device 111 participating in the system 200 in accordance with some embodiments. The UI screens 301 illustrate elements that facilitate the CVO interacting with the curb operations server 101 and the other devices of the system 200. The device 111 includes one or more physical buttons 304, a touch-enabled screen 305, and cellular components 306 for cellular data service to enable data transfer to other devices in the system 200. In other embodiments, the transaction between the CVO and the rider is completed transparently in the background by having the rideshare device 111 send data in the background about use of a curb location to the server 101 and the server 101 completing the transaction by recording a time and location for the pick-up. That is, all parts of the transaction are completed in the background without input by participants.

Referring again to FIG. 3, as part of the rideshare transaction partially illustrated in FIG. 2, the CVO of the rideshare vehicle 207 is prompted to drive to a rendezvous point to meet and provide a ride to the rideshare participant 203. This type of interaction is substantively distinct from a conventional rideshare interaction in which a CVO is directed directly to a current location of the rideshare participant 203 or a location of choice of the rideshare participant 203. Instead, as illustrated in FIG. 2, both the rideshare requesting device 242 and the CVO of the rideshare vehicle 207 are directed to a curbside location selected by logic operative on the server 101. As illustrated in the system 200, this location is the first curbside location 202. The UI screens 301-303 illustrate the communication of one or more of the server 101 and the rideshare server 241 providing instructions to the CVO operator on the screen 305 of the rideshare device 111.

Through a first UI screen 301, the rideshare device 111 prompts the CVO to select one of a plurality of street locations as the rendezvous point within the municipality corresponding to one of a plurality of software-generated and selectable buttons 311-313 on the first UI screen 301. According to some embodiments, each of the buttons 311-313 includes text-based location information about respective available curbside locations to serve as the rendezvous point. For sake of simplicity, this text-based information about these locations is labeled “LOCATION 1”, “LOCATION 2”, and “LOCATION 3”, respectively, for the buttons 311-313. In practice, this information would be specific to the street names and other information associated with the actual municipality (e.g., 601 Riverside Ave). In addition, at least according to some embodiments, each of the buttons 311-313 also includes a price associated with a curbside use of each of the locations 1-3. That is, each of the selectable buttons includes a price customized to the particular transaction between the rideshare device 111 of the CVO of the rideshare vehicle 207 and the rideshare requesting device 242 of the rideshare participant 203. For example, the price for each location 1-3 is customized according to one or more of: a current time of the day, a current day of the week, a local traffic condition of each respective location 1-3, a current distance between the rideshare requesting device 242 and the respective locations 1-3, and a current distance between the rideshare device 111 and the respective locations 1-3. By seeing both the locations 1-3 and the respective prices for using the locations 103, the CVO can make the determination about how much the CVO is willing to spend for a particular location of the three location options corresponding to the buttons 311-313.

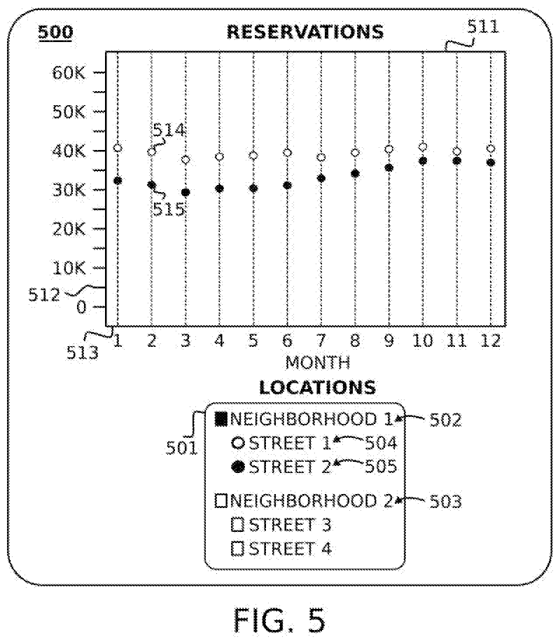

A second UI screen 302 prompts the CVO of the rideshare vehicle 207 to confirm the location selected in the first UI screen 301—in this example, location 2. As shown, the second UI screen 302 includes read-only information such as an estimated time to arrival (ETA) 323 and a fee or fee rate 324 for the second location (“LOCATION 2”). The fee or fee rate 324 is the same or different for each of the locations 1-3 and the fee corresponds to the respective UI buttons 311-313. For the embodiments of different prices, the CVO can make the determination about how much the CVO is willing to spend for a particular location of the three location options by confirming to accept or cancel the transaction by activating one of the two UI buttons 321, 322, respectively. Based on the different prices to reserve the respective rendezvous points, the behavior of the CVO can be shaped by the system 200 to load balance use of certain locations by dynamically pricing the respective rendezvous points as demand for use of these locations within the municipality goes up and down. That is, the CVO can choose to accept to pay a higher price for convenience, or can choose a lower price at the expense of perhaps a larger ETA 323 or perhaps a less convenient (e.g., busier, more crowded, few vehicle lanes) location in the municipality. As part of feedback mechanism, municipality users, as price setters, can adjust prices for the respective locations 1-3 for future transactions by looking at use rates of the respective locations 1-3 aggregated over time as further discussed in relation to FIG. 5 below.

The second UI screen 302 provides two software-generated buttons 321, 322 to either accept or cancel confirmation of using the second location corresponding to the selection of the second UI button 312 of the first UI screen 301. While not illustrated, the second UI screen 302 includes other information such as text indicating, for example, that the second location, corresponding to the second UI button 312, will be held by the system 200 and the curb operations server 101 for at least the ETA time 323 while the CVO is in route to physically complete the rideshare transaction, under the assumption that the CVO has actuated a first “accept” UI button 321 and not a second “cancel” button 322. In certain embodiments, due to the use of the second UI screen 302 by a CVO as a busy driver, the UI includes a timer counting down from a predetermined number of seconds in which the UI and the system 200 automatically accepts the selection 311-313 that the CVO initially accepted on the first UI screen 301 (e.g., after 10, 15, or 20 seconds, the first UI button 321 is effectively actuated). This countdown timer is a mechanism to reduce a number of interactions with the rideshare device 111 while the CVO is operating the vehicle 207.

A third UI screen 303 prompts the CVO of the rideshare vehicle 207 for further input after the CVO has reached the rendezvous point 208—the first curbside location 202 inside the first geofence boundary 201 in the system 200. The third UI screen 303 prompts for selection of one of three possible options about the first curbside location 202 and the rideshare, curbside use transaction. That is, the device 111 asks if the curbside system 200 was used. When activated, a first UI button 331, labeled “YES”, corresponds to successful use of the first curbside location 202. If the first UI button 331 is activated by the CVO, the fee associated with using the first curbside location 202 is charged and accounted in the system 200 such as by the curb operations server 101. A second UI button 332 labeled “CURB TAKEN” corresponds to a scenario in which the ridesharing transaction is completed near the first curbside location 202, but where it was not possible for the CVO to get the vehicle 207 within the first geofence boundary 201 and meaningfully use the curbside location 202 such as due to unexpected pedestrian traffic, parked cars, or other physical transient obstacle. When actuated, the second UI button 332 activates a partial fee and completes the transaction, or would not charge the CVO or the rideshare operator for use of the first curbside location 202. A third UI button 333 labeled “NO” corresponds to a scenario in which the ridesharing transaction is completed substantially outside of the first curbside location 201 or a scenario in which the ridesharing transaction is not completed due to the rideshare participant 203 and the CVO operator not physically meeting for the rideshare activity. In this third scenario corresponding to actuation of the third UI button 333, no fee is assessed to the CVO or the rideshare operator for use of the first curbside location 202.

These UI screens 301-303 illustrate how a CVO operating a vehicle or service within the municipality is assessed a use fee for a curbside location where previously no mechanism was possible to assess this fee and to shape curbside use of the various curbside locations throughout a municipality. While the curb operations server 101 is described as providing the mechanisms associated with the UI screens 301-303, a combination of devices may be used in cooperation with the server 101 to facilitate the same. In general, at the conclusion of the transaction with the system 200, one or more of: the CVO of the vehicle 207, the operating company employing the CVO and the rideshare server 241, and the rideshare participant 203 provide payment to the curbside system 200 and the entity operating the curb operations server 101 for use of the first designated curbside location 202 adjacent to the first street 221.

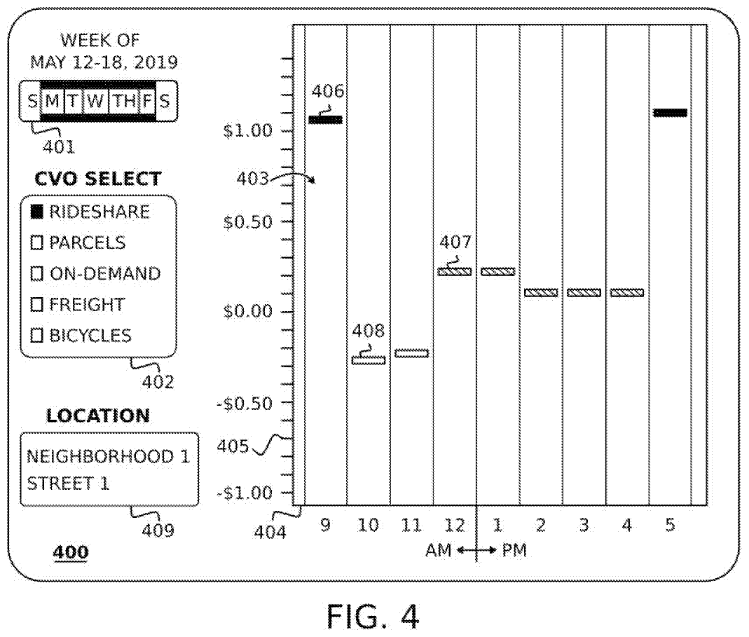

FIG. 4 illustrates a user interface 400 of a device for adjusting curb use fees in a municipality in accordance with some embodiments. The user interface 400 facilitates interactions with one or more devices in the system 200 including the curb operations server 101. The user interface 400 includes three types of selection components 401-403 corresponding to certain information provided to the system. User input received in the selection components 401-403 is for a location indicated in a location 409—specifically for curbside uses of an illustrative “street 1” in an illustrative “neighborhood 1.”

A first selection component 401 is a day-of-week UI selection component through which a user selects one or more days of a particular week or other time period to adjust prices of various curbside locations such as the first and the second curbside locations 202, 212. A second selection component is a CVO selection component 402. Through this component 402, the user selects one or more of types of curbside uses. In this example, these curbside uses correspond generally to the set of devices 110 representing various entities operating curbside services in the municipality. Specifically, in this example, the CVO selections available in the user interface 400 are: ridesharing services, parcel delivery services labeled “PARCELS”, on-demand delivery services, freight pick-up and delivery services, and bicycle rental services labeled “BICYCLES”. Each of these CVO selections includes a radio button box that toggles on and off to select the same. When selected, such as the rideshare services in the CVO selection component 402, these services are provided a fee for each curbside use according to a price and time set in a third selection component 403. The third selection component 403 provides a vertically arranged slider bar along a price scale 405 for each hour of a day along an x-axis 404. For sake of convenience in illustration, only some of the 24 hours of the day are illustrated for selected days M-F.

The user interface 400 enables dynamic pricing of a set of curb locations that is part of a curb inventory in the location 409 of a municipality. Each slider bar 406-408 changes visually according to at least one aspect when moved vertically along the price scale 405 to indicate to a user a particular price region within the price scale 405. In this example, as illustrated, moving from a high, positive fee 406 to a moderate positive fee 407 changes a slider bar from a first state illustrated as solid (406) to a second state illustrated as striped (407). Moving from the second state to a third state in the range of a negative fee 408 changes the slider bar to a hollow state (408) indicating to the user that the user has moved the slider to a particular portion of the price scale 405 for the corresponding hour along the x-axis 404. In other embodiments where a color change is possible, each step along the price scale 405 is a different hue or color such that the user is visually apprised of each step in the third selection component 403.

As illustrated in the user interface 400, the user is setting prices in U.S. dollars for ridesharing as indicated by the selection in the CVO selection component 402. Along the x-axis 404, time is broken into time blocks—hours in this example—where a same price is set separately for each time block. Based on a preference by the user, the user slides each slider bar up or down to a final location corresponding to, for example, a price per minute or a price per transaction at which to rent the particular curbside locations associated with this particular user interface 400. Note that the user has set prices for the 10:00 a.m. and the 11:00 a.m. times to a negative value. A negative value for a fee is equivalent to a rebate to use particular curbs. The rebate would be applied to an overall charge applied for a transaction involving a particular curbside location in the times where the negative values are set. The negative value is designed to incentivize curbside use away from busy times of the day relative to other times for the particular curb locations being priced through this user interface 400. The prices set in this user interface 400 correspond to the fee or fee rate 324 of the read-only portion of the second UI screen 302. Through the ability to dynamically price curbside use, the municipal user can shape congestion in a particular area of the municipality by increasing or decreasing the fee associated with each use associated with each particular location (e.g., the location 409). Without this user interface 400, for a curbside meter such as the parking meter 228 adjacent to the first parking stall 232 illustrated in FIG. 2, a municipality user is required to physically appear at the meter 228 and set a price in a component of the physical meter 228 to charge for use of the first parking stall 232. Setting pricing dynamically in a set of physical meters substantially contemporaneously throughout a municipality would be impossible without a user interface such as the user interface 400 and the curbside system 200.

Pricing is set on a location-by-location basis with prices as desired, and the user interface 400 is illustrative of the pricing mechanism generally. The process of using the user interface 400 is repeated for each geographic area in the municipality. Thereby, price setting for curbside use is set on an area-by-area basis. Alternatively, the pricing can be set for all curbside uses in an entire municipality. Or, yet alternatively, price setting is performed on a location-by-location basis down to a level of geographic resolution of GPS coordinates in the municipality. Preferably, the municipality user, as manager of curbside uses, selects prices for fees and rebates that incentivize the types of activities that the municipality has designated for the particular locations. That is, the municipality as user sets separate prices for a first activity type (e.g., ridesharing) independently of a second activity type (e.g., parcel delivery).

FIG. 5 illustrates a user interface 500 for a municipality user to access previous fee collection of a set of curb locations according to some embodiments. In the user interface 500, two locations of a plurality of curb use locations are selected in a selection interface element 501. In this example, a first geographic area 502 labeled “neighborhood 1” is selected, and a second geographic area 503 is not selected. Data corresponding to two areas 504, 505 labeled “street 1” and “street 2” of the first geographic area 502 are plotted in a first display element 511. In operation, the labels would correspond to actual street names from the streets of the actual municipality. The two geographic areas 504, 505 correspond to a first group of curbside locations and a second group of curbside locations. In the interface element 501, the icons to a left side of the two selected areas 504, 505 provide a legend for a first data plot 514 and a second data plot 515, respectively, in the display element 511.

An x-axis 513 in the display is broken into months of a year. A y-axis 512 displays a fee amount in thousands of U.S. dollars for each of the first and second data plots 514, 515. For each month along the x-axis 513 (numbered 1-12), the dollar amounts for each of the two areas 504, 505 are plotted. One or more conclusions are drawn from a comparison of fees collected from curbside reservation transactions on “street 1” 504 and “street 2” 505, respectively. For example, based on the values in the display element 511, more fees, month after month, are collected for “street 1” 514 compared to “street 2” 515. Also, a difference between the total fees, month after month, is diminishing generally as evident at months 10-12. Consequently, assuming that a municipality targets a same revenue target for both streets 504, 505, a user could conclude that whatever pricing scheme has been implemented for these two regions in the first geographic area 502 is working to drive these two fee totals under the additional assumption that all other factors are held constant. A same comparison and similar display in the display element 511 could be repeated for “street 3” and “street 4” of the second geographic area 503. Using this methodology, and through the user interface 500, a municipality user can go region by region and assess fee collection associated with each group of curbside uses throughout the municipality.

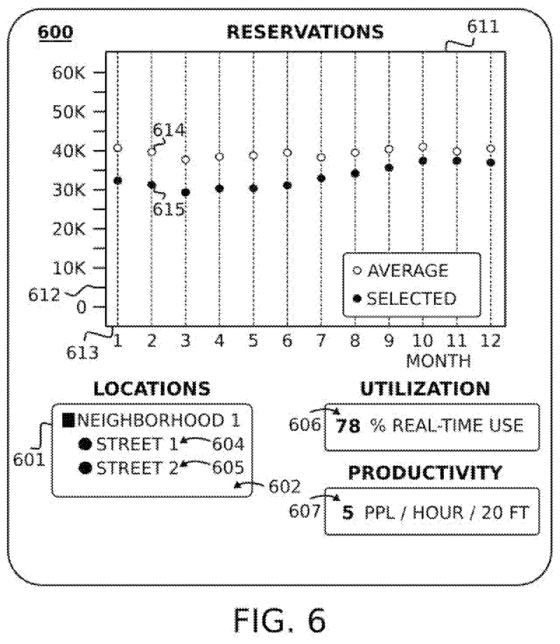

FIG. 6 illustrates a user interface 600 for a municipality user to access previous fee collection of a set of curb locations according to other embodiments. The user interface 600 is similar to the user interface 500 of FIG. 5. In the user interface 600, one location of a plurality of curb use locations is selected in a selection interface element 601. In this example, a first geographic area 602 labeled “neighborhood 1” is selected, and this area 602 includes both a first sub-area 604 and a second sub-area 605 labeled “street 1” and “street 2,” respectively. Data corresponding to a sum of fees collected from the first geographic area 602 are plotted in a first display element 611 as a second plot 616 and positioned for comparison against a first plot 614 representing values of an average of all fees collected throughout all geographic regions in the municipality. The two sub-areas 604, 605 correspond to a first group of curbside locations and a second group of curbside locations in the municipality that belong to the first geographic area 602. Continuing the example of the system 200, the first curbside location 202 and the second curbside location 212 are part of the first sub-area 604 where the illustrated portion of the first street 221 is a same location as the first sub-area 604.

An x-axis 613 in the display is broken into months of a year. A y-axis 612 displays a fee amount in thousands of U.S. dollars for each of the first and second data plots 614, 615. For each month along the x-axis 613 (numbered 1-12), the dollar amounts are provided. One or more conclusions are drawn from a comparison of fees collected from curbside reservation transactions that have transpired in the first geographic area 602 compared to the average of all geographic areas in the municipality. For example, based on the values in the display element 611, more fees, month after month, are collected on average when compared against the amounts for the first geographic area 602 in the second plot 615. Also, a difference between the fees as in the plots 614, 615, month after month, is diminishing generally as evident in the trend from month 6 and moving toward months 10-12.

The user interface 600 also includes two additional values for the first geographic area 602: a utilization rate 606 and a productivity value 607. According to some embodiments, the utilization rate 606 corresponds to a current real-time use as a percentage of time-to-the minute of a current day in which the user interface 600 is shown. In other embodiments, the utilization rate 606 is an average utilization percentage as determined across all 24 hours of the days of the 12 months corresponding to the data plotted in the display element. In this example, this value is 78%. According to some embodiments, the productivity value 607 is a value determined in units of transactions (labeled as “ppl” or people) per hour per unit length of curb in the first geographic area 602. In this example, this productivity value is approximately five (5) curbside transactions per hour per each twenty feet of curb such as along the first street 221 illustrated in the system 200. Using this methodology, and through the user interface 600, a municipality user can go region by region and assess fee collection associated with each group of curbside uses throughout the municipality. The municipality, based on experience, may have certain targets for certain locations or groups of locations for utilization, productivity, or both utilization and productivity. The municipality could then set the prices and incentives to reach its goals for each of the regions in the municipality as exemplified by the first geographic area 602.

As an example of shaping behavior for the first geographic area 602, a municipality user may, for a particular second day of a particular week, desire to steer traffic away from the first geographic area 602 of the municipality (e.g., near a convention center) due to construction in the particular area. Drop-off and pick-up curbside events would negatively impact traffic flow in the streets in and around the particular location. On a day ahead of the second day, the municipality through the curb operations server 101 of the system 200 provides notice to the system 200 by providing geolocation data and related use fee data to the server 101. At a designated time ahead of a start of the second day, such as at a designated time on the first day, the system sends out a notification to each mobile device of each registered driver or commercial vehicle operator (CVO) that has used any curbside location within the first geographic area 602. The notification includes a geolocation indicator and a price increase for use of curbside locations within the construction zone where the price increase serves as an incentive for the CVOs to keep away from the construction zone over a certain timeframe on the second day. This example is just one example of many curbside pricing, geofencing, and metering scenarios serviced by the system 200 and related devices. The longer the system 200 is used, the more data is collected and serves as a model and basis for correlating curbside use behavior with curbside use fees.

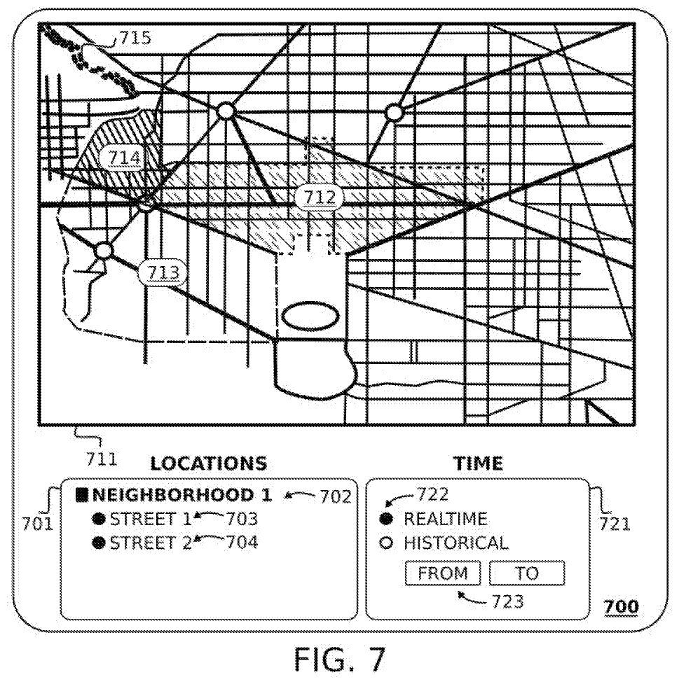

FIG. 7 illustrates a block diagram of a graphical user interface 700 having a map 711 and interactive regions 712-714 for planning use of curbside locations therein and setting prices based on past data collected in the system 200 according to some embodiments. For sake of convenience of illustration and reproducibility, the map 711 and user interface 700 are illustrated with black lines. In particular, the map 711 is represented by a set of black lines representing streets in a municipality and a few limited types of geographic surface structures 715 such as rivers and parks that do not have curbside locations. Only a portion of the entire map 711 is shown in the user interface 700. In practice, the map includes use of color, shading, and other types of features of elements of the map 711. These features remain constant or change from moment to moment in time as the user views and interacts with the map 711. The changing features convey multiple layers of information in the same graphical user interface 700. In the user interface 700, three colors are represented by three different shading patterns corresponding to respective regions 712-714.

The graphical user interface 700 is used in at least two different modes for the municipality: a first mode corresponding to a real-time use of curbs as measured by curbside transactions, and a second mode corresponding to historical use and fee collection from curbside transactions. These modes are operative via the map 711 of the user interface 700. Each of the first and second modes is briefly described and further illustrate aspects of the system 200 and elements of FIGS. 1-6. That is, the graphical user interface 700 further enables certain features discussed in relation to FIGS. 1-6.

In the first mode, minute by minute, the system 200 is in use and the user interface 700 represents that use. In substantially real-time, as indicated by a user selection of a time selection element 722 in a second user interface element 701, as data are collected by the server 101, and database therein as understood by those in the art, elements of the map 711 and the user interface 700 are updated. Any one or more features graphically illustrated in the map 711 and associated with the pre-determined regions 712-714 are changed based on a change to their respective data in the server 101 of the system 200. The user interface 101 receives the data from the server 101.

For example, a third region 714 changes from a first clear “shading” pattern, as illustrated by a second region 713, to a third shading pattern. In this example, this third pattern represents a red color, the second pattern represents a green color, and a first shading pattern represents a yellow color as illustrated in a first region 712. In response to a municipality user selecting the first region 712, additional information is illustrated in a first user interface element 701. For example, the first element 701 displays a name or label 702 associated with the first element 701, and sub-area names 703, 704 associated or grouped in the first region 712. Additional information includes data up to the minute from the start of a current day in progress for the first region 712. In this example, a utilization rate 606 and a productivity value 607 can be shown for “neighborhood 1.” When the first region 712 is enlarged, the map 711 is re-sized and each of the respective streets illustrated in the user interface 700 as a first street 703 (“street 1”) and a second street 704 (“street 2”) are indicated in the interface element 701 and are highlighted in the corresponding region of the map 711. In a first example, the red color of the third region 714 corresponds to a curbside use rate per hour that exceeds a pre-determined use rate threshold indicating that a bottleneck in the system is imminent or already occurring. Each of a plurality of colors or changes to a particular aspect of the regions 712-714 is coupled to or provided a threshold such that a plurality of thresholds is provided. As an example, for a change to a red color, a first threshold is provided for a value crossing into this red-color-based behavior of the system, and a second threshold is provided for the value crossing into a yellow-color-based behavior of the system for each particular region 712-714.

In certain embodiments of the first mode, with or without user intervention, price per transaction or price per minute for curbside uses in the first region 712 is increased for that hour based on the data crossing the use threshold for a rate of use per hour or for an amount of revenue charge or assessed per hour. Such increased metering is performed on a region-by-region basis (e.g., for any of the regions 712-714) or on a sub-area 703, 704 basis. In certain embodiments, the dynamic metering (e.g., price increase or decrease) is performed dynamically in substantially real-time as data are updated, down to a location-by-location basis such as increasing a price for use of the first curbside location 202 relative to the second curbside location 212 even though these locations may belong to a same first sub-area 703. In other embodiments, crossing the threshold causes the system 200 to lower a price per use or per minute in neighboring regions such as lowering a price for the second curbside location 212 relative to the first curbside location 202 to shape traffic patterns away from a congestion event at the first curbside location 202 in that hour. In yet other embodiments, a price for use is increased or decreased for a particular location (e.g., neighborhood or sub-area 703 basis) in response to a revenue generation value per unit time (e.g., per hour) crossing a pre-determined threshold value for that location. This event is reflected in the shading or color change in the map 711 or sub-portion thereof. In certain embodiments, the overall area such as the first region 712 changes color, and a subsequent selection of this region 712 or enlargement of the map 711 allows the user to visually drill-down into the particular region of the municipality experiencing the event. That is, a revenue productivity rate for the municipality crosses a productivity threshold particular location 702 or sub-area 703, and, in response, use of a new region is incentivized by either communicating other regions to devices used by CVOs or by increasing or decreasing a price of a same or a different sub-area 703, 704 for curbside use.

In general for the first mode, multiple variables in the curbside transactions are monitored, and one or more actions are taken in response to each threshold for each area being crossed for a particular unit of time. Further, the multiple variables that are monitored are reflected in elements of the user interface 700. For example, certain features of the map 711 are updated according to a pre-determined scheme corresponding to an amount of compliance with a threshold related to, for example, utilization, productivity, or both utilization and productivity.

According to the second mode, the user interface 700 and the map 711 are updated to reflect data as selected from certain previously gathered historical data. The user interface 700 displays the historical data to the user for planning and other purposes when this option in the time interface element 722 of the first user interface element 701. That is, not only is the user interface 700 useful to show real-time updates and status based on one or more of: current values and historical values collected in the system by the server 101, when selected to do so, the user interface 700 also displays a history of the respective regions 712-714 both graphically in the map 711 and in details provided in, for example, components of the first interface element 701.

Depending on the user selections in the user interface 700, data are averaged or aggregated over a time selectable by the user in the second interface element 721. For example, the time period to be displayed in the user interface 700 is: a week-to-date period, a month-to-date period, a previous week period, a previous month period, a previous year period, or a historical time range 723 as understood by those in programming arts. Data are provided in the user interface elements and in the map 711 including in the features of the regions 712-714. In this user interface 700, a user, such as a municipality employee, graphically selects and progressively drills down into the graphically represented numbers to understand use of respective curbside locations in the municipality. For example, the user is able to access use data graphically for the three regions 712-714 and compare use of curbside uses of the same based on changes to, for example, a shading or coloring of the regions 712-714 based on one or more metrics crossing a respective threshold for the particular historical time range 723. While not illustrated in the user interface, the user alters a threshold for the entire displayed map region or a respective threshold for each of the plurality of regions of the municipality or subsection thereof as represented by the three regions 712-714.

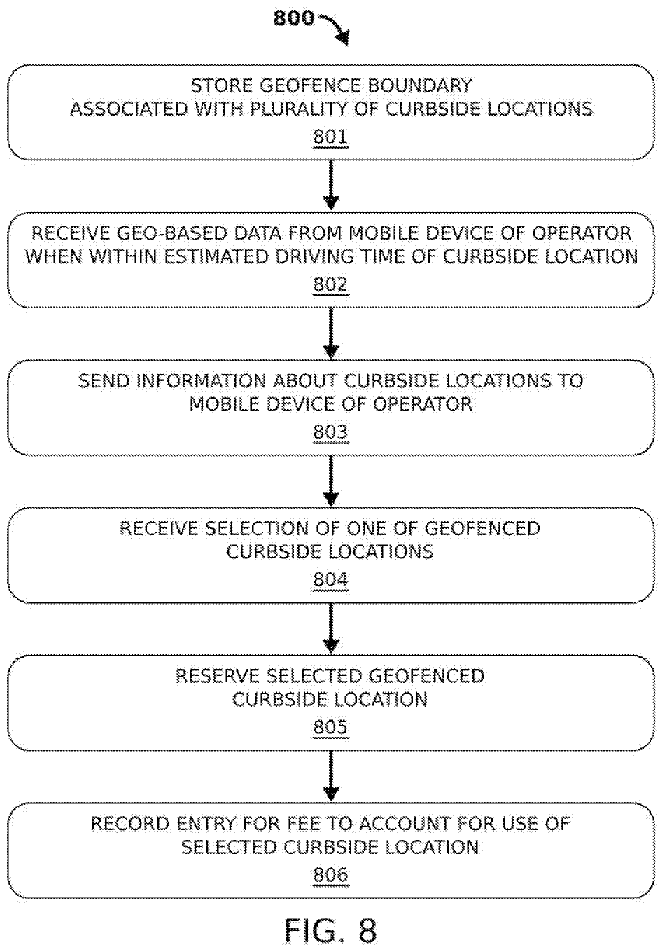

FIG. 8 is a block diagram of a method 800 of providing geofencing and curbside metering to participating devices in a use transaction according to some embodiments. A method includes various steps involving two or more devices in the system 200 including, for example, an operations device such as the curb operations server 101 and a participant device such as a commercial vehicle operator device (e.g., the rideshare device 111), the rideshare requesting device 242, and the parcel delivery device 112.

At block 801, a device stores at least one first geo-fence boundary associated with a particular curbside location inside of a region of a municipality. At block 802, the device receives geo-based data from a mobile device of a commercial vehicle operator and the designated destination for that vehicle to which the CVO is driving to complete the transaction (e.g., make the curbside pick-up). In other embodiments, within an estimated travel time of the geo-fence boundary. At block 803, the device sends information associated with a plurality of available geo-fenced curbside locations to a mobile device of the commercial vehicle operator. At block 804, the device receives a selection of one of the pluralities of the available geo-fenced curbside locations. For example, the commercial vehicle operator activates a component of a user interface on the mobile device such as one of the selectable buttons 311-313 on the first UI screen 301. At block 805, the device reserves the selected curbside location for a pre-determined time. At block 806, the device keeps track of information by recording an entry in a database in support of charging a fee to an account of the commercial vehicle operator. In some embodiments, the fee is confirmed based on detecting a crossing of the mobile device over the geo-fence boundary within a pre-determined time after receiving the selection for the reserved curbside location. The mobile device shares its location by sending geo-based data to the device.

In certain embodiments, various additional steps of the method 800 are performed. For example, after determining that the first geo-fence boundary is crossed, the device 101 determines a dwell time duration of the mobile device of the commercial vehicle operator from a time that the mobile device crosses the geo-fence boundary and the mobile device of the commercial vehicle operator exits the geo-fence boundary. The fee charged to the account of the commercial vehicle operator is further based on the determined dwell time duration. The device also sends a notification to the mobile device of the commercial vehicle operator, and the notification includes at least some information based on the determined dwell time duration.

The method 800 also includes determining a number of commercial vehicle operator devices within a time window of the particular curbside location inside of the region of the municipality based on respective estimated travel times for available commercial vehicle operator devices and sending a notification based on the same. A price for occupancy of the particular curbside location is based on the determined number of commercial vehicle operators within the time window, and the notification delivered to the mobile devices of the commercial vehicle operators includes the determined price for occupancy in some embodiments. The device can also send a message that includes a direction to the mobile device of the commercial vehicle operator to the particular reserved curbside location or includes an estimate of travel time to each of the locations. Information associated with each of the plurality of available geo-fenced curbside locations for a particular CVO can include a price per use or a price per unit of time for using the available geo-fenced curbside locations, and this price can be included in the message sent to the mobile device of the CVO.

The method 800 from the perspective of a server 101 can be implemented with a device that includes at least a processor, a storage component that stores a set of geo-fence boundaries associated with respective curbside locations inside of a geographic region, and a transceiver configured to send and receive data from a mobile device of a commercial vehicle operator. This data can include geo-based data or data that includes GPS or geographic information from a mobile device of the commercial vehicle operator. The processor of the server 101 is configured to, for example, receive a request for an available curbside location within a predetermined amount of time of a current location of the mobile device of the CVO based on certain data. The processor determines an estimated travel time to each boundary of a pre-determined number of boundaries of the set of geo-fenced boundaries, and based on the determined travel time, selects a plurality of available curbside locations from the set of geo-fenced boundaries to facilitate a curbside use or transaction. The server 101 sends certain information associated with the selected plurality of available geo-fenced curbside locations to the mobile device of the commercial vehicle operator. In response to the CVO interacting with the corresponding mobile device, the server 101 receives a selection of one of the pluralities of the available geo-fenced curbside locations, reserves the selected curbside location for a pre-determined time, and stores information about a fee for the mobile device of the CVO based on receiving an indication associated with the mobile device crossing the selected, available geo-fenced curbside location within a pre-determined time after the server 101 receives the selection for the reserved curbside location.

The server 101 can perform certain other activities. For example, the server 101, through its processor and instructions operating thereon, determines that a first geo-fence boundary of the selected, available geo-fenced curbside location is crossed based on receiving geo-based data from the mobile device, and after determining that the first geo-fence boundary is crossed, determines a dwell time duration of the mobile device of the commercial vehicle operator until the mobile device of the commercial vehicle operator exits the geo-fence boundary. The fee charged to the account of the commercial vehicle operator can be based on the determined dwell time duration. The server 101 can send a notification to the mobile device of the CVO for the curbside use transaction, where the notification includes information based on the determined dwell time duration. In the system 200, the server 101 receives geo-location data from each of a plurality of commercial vehicle operator devices that are proximate or are within a reasonable distance of respective and available curbside locations such as the first and second locations 202, 212. The server 101 determines a number of commercial vehicle operator devices that can service a requested curbside use, from the plurality of commercial vehicle operator devices that are near, devices that are within a time window of the selected curbside location. The server 101 determines a price for occupancy of the selected curbside location based on the determined number of commercial vehicle operators within the time window, wherein the notification delivered to the mobile devices of the commercial vehicle operators includes the determined price for occupancy. In some embodiments, the server 101 sends a notification based on the determined price for occupancy of the particular curbside location to at least one mobile device associated with one or more respective CVOs within the time window. Depending on demand, before sending the information associated with the selected plurality of available geo-fenced curbside locations to the mobile device of the CVO, the server 101 adjusts a first size of the first geo-fence boundary based on demand of the particular curbside location for a particular time period so as to accommodate additional curbside transactions and fit additional vehicles next to a fixed amount of curbs. With this additional mechanism, peak demand for curbside uses can be better accommodated than with fixed-sized curbside regions as in conventional parking spaces or fixed sized and reserved pick-up locations in high-use areas in a municipality. Information sent to a mobile device may include information about the altered size or re-sized location with respect to the adjusted size of the first geo-fence boundary. For example, the server 101 sends a message that includes a direction to the mobile device of the CVO, wherein the direction is to the reserved curbside location with an altered size. The message also can include information associated with each of a plurality of available geo-fenced curbside locations and this information includes a price per use or a price per unit of time for using the available geo-fenced curbside locations so that the CVO can select which location to use to complete a curbside use.

In certain embodiments, the method 800 also includes generating and sending an alert when an aspect of one or more curbside transactions crosses a respective threshold. As a first example, based on a real-time event that a utilization rate for a particular location or set of locations (e.g., the locations 202, 212) exceeds a utilization threshold, a notification is created and delivered such as to the user interface 700 or to a user interface on one or more devices 101, 111, 112, 121, 131, 242 used in the system 200. As a second example, based on a real-time event that a utilization volume rate for a particular set of locations (e.g., one or more of two geographic areas 504, 505) exceeds a utilization volume threshold for a particular hour or other timeframe, a notification is created and delivered such as to the user interface 700. As a third example, based on a real-time event that a number of curbside use requests or a request rate for a particular set of locations (e.g., one or more of two geographic areas 504, 505) exceeds a curbside demand rate threshold for a particular hour or other timeframe, a notification is created and delivered such as to the user interface 700.

Notifications are added to a queue or list of notifications until read or otherwise dismissed from a user interface. Preferably, for each notification, a text-based message is provided in the notification. In certain embodiments, a portion of the map 711 corresponding to a region involved in the particular notification is also included in the particular notification. Each event and corresponding notification are sharable to another device or user account in a same or another communication medium. Further, in certain embodiments, each notification includes a link to additional information such that a user of the UI can drill down and access further detail about the particular event as the subject of the notification. In substantially real-time, by monitoring alerts and updating pricing (e.g., changing a use price by a curb owner, changing a rebate by a municipality) the system 200 adjusts a pricing for a particular area. In some embodiments, notifications are provided to participants (e.g., riders of ride-share services) by the system.

In certain other embodiments, based on a current or a past behavior, a particular CVO can be penalized or tolled for bad behavior that is outside of a norm or limit for proper use. For example, if a first CVO (driver) lingers in parking spot or drop-off location for over 12 minutes in which 2-3 other CVO's could have used the same location, a toll assessed in real-time is applied to the CVO. The CVO, through the application and interface provided by a third party, is assessed: a toll, a fine associated with a license plate of the vehicle being operated by the CVO, a reduced user rating, or another penalty for excessively using the particular location outside of a norm established by the municipality. In certain embodiments, this norm is derived from an average of times of the last N CVO's to use this same location. For example, the norm is derived for similar uses of this location during the same hour of operation of the day for the last 20 business days and this norm is used to compare against a real-time behavior of the particular CVO. According to at least some other embodiments, this norm is encouraged and communicated by delivering a message to a mobile device associated with the particular CVO at a starting time of using the particular location. In certain embodiments, after a current time of use exceeds the calculated norm, and after a predetermined delay in excess of the norm, a message is delivered to the mobile device of the particular CVO to provide notice of the violation and, optionally, the level of incentive for violating the norm. For example, the particular CVO is assessed a $10.00 dollar fee similar to a parking ticket for exceeding the time for use of this space for the desired use of, for example, picking up a passenger.

According to another embodiment of the system described herein, based on a current or past behavior, a particular CVO is incentivized for good behavior instead of being punished for a bad behavior (explained directly above). For example, if a first CVO (driver) quickly gets into and out of a parking spot or a drop-off location faster than a predetermined or calculated time limit, a rebate is assessed in real-time to the CVO. As an example, if the cost of a pick-up is a $1.00 dollar fee for the particular municipality at the particular time of day, the rebate is $0.50 dollars for incentivizing and rewarding the particular CVO to only use the particular spot for less than 90 seconds when an average use time has been determined to be 3.5 minutes for the particular location. The CVO, through the application and interface provided by the system, is assessed a reduced toll, a positive user rating, or another reward for using the particular location inside of a norm established by the municipality. According to some embodiments for an incentive, the norm is determined as described above.

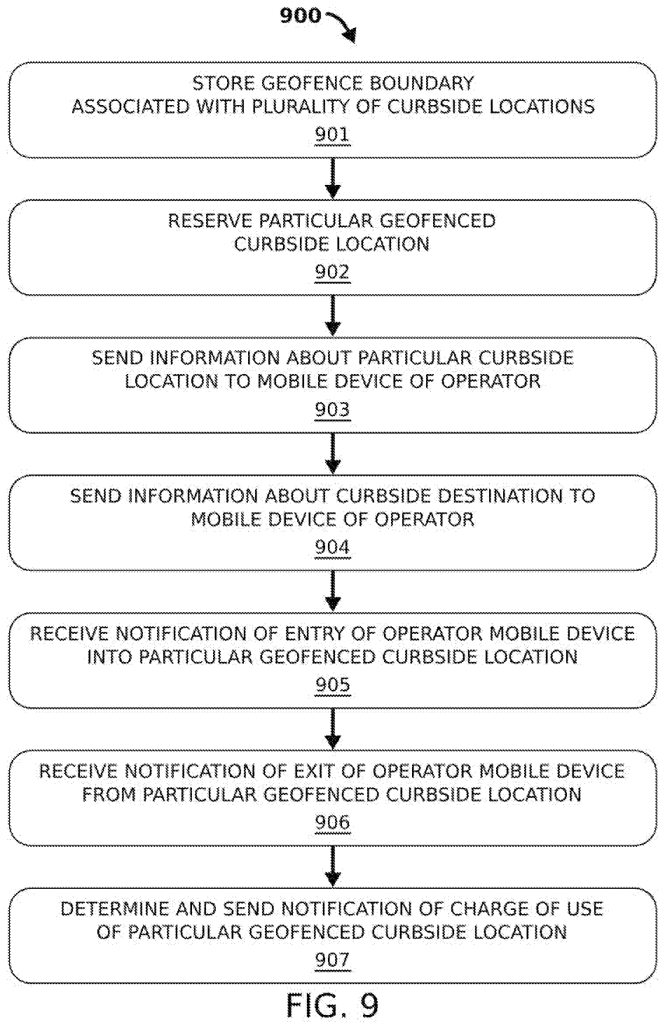

FIG. 9 is a block diagram of an additional method 900 of providing geofencing and curbside metering according to some embodiments. The method 900 is from the perspective of a server or similar device or set of devices that provide curbside services to other participating devices. For example, the method 900 is from a perspective of the curb operations server 101. At block 901, at least one first geo-fence boundary is stored. The first geo-fence boundary is associated with a particular curbside location inside of a region of a municipality. In practice, an entire set of geo-fence-based boundaries are stored, one for each location inside of the municipality that is metered and where a user can be charged a fee for temporary use of the same.

At block 902, based up or triggered by a request for use of the system, a particular geofenced curbside location is identified and reserved. At block 903, information about the particular geofenced curbside location is sent to a mobile device of an operator. That is, directions to or an address of the particular geofenced curbside location is sent to mobile device of the operator. For example, driving directions are provided to the parcel delivery device 112. In other embodiments, the information sent to the device is a notification that the particular geofenced curbside location is a notification that the particular geofenced curbside location is reserved and another application or mechanism provides directions or an address to the particular geofenced curbside location.

At block 904, optionally, additional information about the particular curbside destination is sent to the mobile device of the operator. For example, a usage rate (e.g., dollars per minute) is sent to the mobile device of the operator. As another example, an estimated amount of time to reach the particular geofenced curbside location is sent to the mobile device of the operator. As yet another example, a current occupancy status is sent to the mobile device of the operator so that the operator can anticipate what to expect if arriving to the particular geofenced curbside location. The current occupancy status can take the form of an estimated amount of time from the current time to complete an activity in the particular geofenced curbside location so that the operator of the mobile device can anticipate exigent circumstances of the particular geofenced curbside location.

At block 905, based on GPS or other location data from the mobile device of the operator, the curb operations server 101 receives data associated with, or a notification of, entry of the mobile device of the operator crossing into the geofence boundary of the particular geofenced curbside location such as crossing the first geofence boundary 201 of the curbside location 202. In some embodiments, both the data and the notification are received. In some embodiments, of the method 900, receiving the data and/or the notification is optional in view of receiving other data or notification. At block 906, based on GPS or other location data from the mobile device of the operator, the curb operations server 101 receives data associated with, or a notification of, an exit of the mobile device of the operator crossing out of the geofence boundary of the particular geofenced curbside location such as again crossing the first geofence boundary 201 of the curbside location 202. These data at blocks 905, 906 can be correlated and used together, along with timestamps associated with the same, to confirm use of the particular geofenced curbside location to reduce or eliminate false positives and false negatives of use of the particular geofenced curbside location. The steps associated with blocks 905, 906 include sending to and receiving by the curb operations server 101 of one or more timestamps, times, or time durations.

At block 907, the curb operations server 101 determines and sends a notification of a financial charge associated with use of the particular geofenced curbside location that was reserved at block 902. If no particular geofenced curbside location was used, then a notification of the same is sent such as to the mobile device of the operator. Examples of the notification include sending a real-time message to the mobile device of the operator such as through a UI provided by the curb operations server operator or through a third party who uses the curb operations server 101 such as through an application programming interface (API). That is, the curb operations server 101 provides an API that facilitates interaction with the server 101 by various devices.

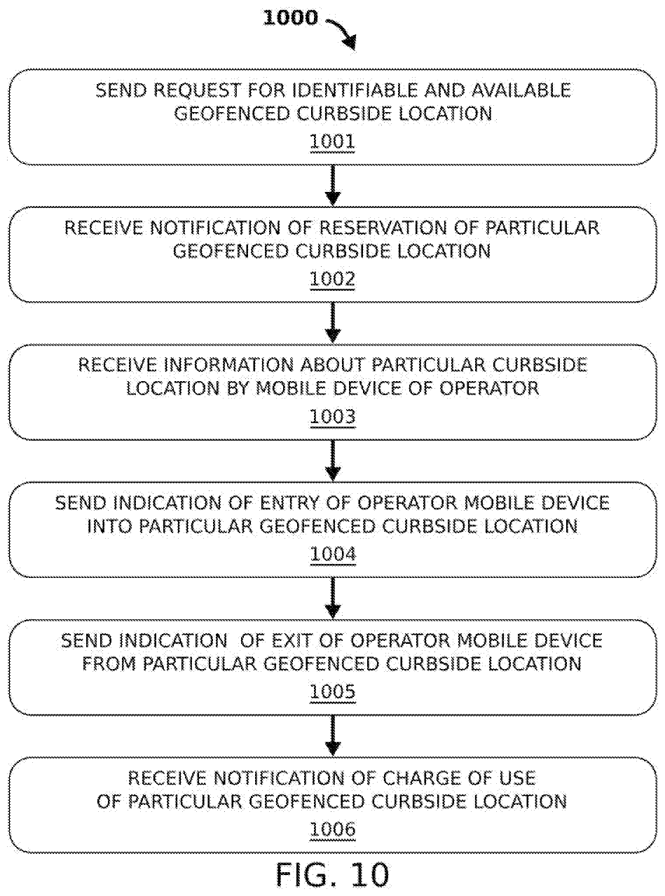

FIG. 10 is a block diagram of an additional method 1000 of providing geofencing and curbside metering according to some embodiments. The method 1000 is from the perspective of a participant device or set of devices that receive curbside services from the curb operations server 101. For example, the method 1000 is from a perspective of the rideshare device 111. At block 1001, a participating device sends a request for an identifiable and available geofenced curbside location. For example, such curbside location is the curbside location 202 having the first geofence boundary 201.

At block 1002, the participating device receives notification of reservation of the particular geofenced curbside location. At block 1003, the participating device receives information about the particular geofenced curbside location. An operator having or using the participating device is thereby informed about where to go. At block 1004, with or without input from the operator, the participating device sends an indication of entry of the mobile device into the particular geofenced curbside location. At block 1005, with or without input from the operator, the participating device sends an indication of exit of the mobile device from the particular geofenced curbside location. For example, the entry and the exit of the mobile device, such as the rideshare device 111 using the location 202, is based on GPS-based information (e.g., actual GPS coordinates, GPS coordinates, GPS data) determined by the mobile device shared to the curb operations server 101.

At some time after a time of use of the particular geofenced curbside location, at block 1006, a notification of a financial charge for use of the particular geofenced curbside location is received. As a specific example, a notification is sent to and received by the participating device in the form of a UI-based message or an SMS-based text message indicating at least the final price for using the particular geofenced curbside location for the particular transaction that has just completed. Such message is sent based on the curb operations server 101 receiving the indication of exit of the participating device exiting the geofenced boundary at block 1005.

As another specific example of a notification, a third party device (e.g., server) receives transaction information (e.g., charge or use fee information) from the curb operations server 101. At the end of a day, or at the end of a review period (e.g., week, month), charges for use by the particular participating device (e.g., rideshare device 111) are communicated to the rideshare server that supports the rideshare device 111. When the rideshare operator is offline, the rideshare operator can then review the charges for participating in the curbside system 100. Each financial charge for curbside uses in the municipality are line-item costs such that the rideshare participant using the rideshare device 111 is apprised of the charges and see the times and places and costs associated with use of the various curbside locations. That is, each notification at block 1006 takes the form of a line-item entry in an accounting user interface (UI) available to the user. The notifications are provided, by example, through a UI provided by the curb operations server operator or through a third party who uses the curb operations server 101 through its API. Thus, the curbside system 100 provides various mechanisms to various participants. The various activities require multiple perspectives in order to make and use the various features described herein. The methods 800, 900, 1000 are a few of the various mechanisms provided by the curbside system 100.

Conclusion. Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
storing a first geo-fence boundary associated with a particular curbside location inside of region of a municipality;
receiving geo-based data from a mobile device of a commercial vehicle operator when within an estimated driving time of the geo-fence boundary;
sending information associated with a plurality of available geo-fenced curbside locations to a mobile device of a commercial vehicle operator;
receiving a selection of one of the pluralities of the available geo-fenced curbside locations;
reserving the selected curbside location for a pre-determined time; and
charging a fee to an account of the commercial vehicle operator based on detecting crossing the geo-fence boundary within the pre-determined time after receiving the selection for the reserved curbside location.

2. The method of claim 1, further comprising:
determining that the first geo-fence boundary is crossed based on the received geo-based data; and
after determining that the first geo-fence boundary is crossed, determining a dwell time duration of the mobile device of the commercial vehicle operator until the mobile device of the commercial vehicle operator exits the geo-fence boundary, wherein the fee charged to the account of the commercial vehicle operator is further based on the determined dwell time duration.

3. The method of claim 2, further comprising:
sending a notification to the mobile device of the commercial vehicle operator, wherein the notification includes information based on the determined dwell time duration.

4. The method of claim 1, further comprising:
determining a number of commercial vehicle operator devices within a time window of the particular curbside location inside of the region of the municipality based on respective estimated travel times for available commercial vehicle operator devices; and
determining a price for occupancy of the particular curbside location inside of the region of the municipality based on the determined number of commercial vehicle operators within the time window.

5. The method of claim 4, further comprising:
sending a notification based on the determined price for occupancy of the particular curbside location to mobile devices associated with the respective commercial vehicle operators within the time window; or
delivering a notification to the mobile device of the commercial vehicle operator that includes the determined price for occupancy.

6. The method of claim 1, further comprising:
adjusting a first size of the first geo-fence boundary based on an indication of a demand of the particular curbside location.

7. The method of claim 1, further comprising:
sending a message including a direction to the mobile device of the commercial vehicle operator to the particular curbside location.

8. The method of claim 1, wherein the information associated with each of the plurality of available geo-fenced curbside locations includes an estimate of travel time to each of the locations.

9. The method of claim 1, wherein the information associated with each of the plurality of available geo-fenced curbside locations includes a price per use or a price per unit of time for using the available geo-fenced curbside locations.

10. A device comprising:
a storage component storing a set of geo-fence boundaries associated with respective curbside locations inside of a geographic region;
a transceiver configured to receive geo-based data from a mobile device of a commercial vehicle operator; and
a processor configured to:
receive a request for an available curbside location within a predetermined amount of time of a current location of the mobile device based on the geo-based data.
determine an estimated travel time to each boundary of a pre-determined number of boundaries of the set of geo-fenced boundaries;
based on the determined travel time, select a plurality of available curbside locations from the set of geo-fenced boundaries;
send information associated with the selected plurality of available geo-fenced curbside locations to the mobile device of the commercial vehicle operator;
receive a selection of one of the pluralities of the available geo-fenced curbside locations;
reserve the selected curbside location for a pre-determined time; and
store information about a fee for the mobile device of the commercial vehicle operator based on receiving an indication associated with the mobile device crossing the selected, available geo-fenced curbside location within the pre-determined time after receiving the selection for the reserved curbside location.

11. The device of claim 10, wherein the processor is further configured to:
determine that a first geo-fence boundary of the selected, available geo-fenced curbside location is crossed based on receiving geo-based data from the mobile device; and
after determining that the first geo-fence boundary is crossed, determine a dwell time duration of the mobile device of the commercial vehicle operator until the mobile device of the commercial vehicle operator exits the geo-fence boundary, wherein the fee charged to the account of the commercial vehicle operator is further based on the determined dwell time duration.

12. The device of claim 11, wherein the processor is further configured to:
send a notification to the mobile device of the commercial vehicle operator, the notification including information based on the determined dwell time duration.

13. The device of claim 10, wherein the processor is further configured to:
receive geo-location data from each of a plurality of commercial vehicle operator devices;
determine a number of commercial vehicle operator devices, from the plurality of commercial vehicle operator devices, that are within a time window of the selected curbside location; and
determine a price for occupancy of the selected curbside location based on the determined number of commercial vehicle operators within the time window, wherein the notification delivered to the mobile devices of the commercial vehicle operators includes the determined price for occupancy.

14. The device of claim 13, wherein the processor is further configured to:
send a notification based on the determined price for occupancy of the particular curbside location to mobile devices associated with the respective commercial vehicle operators within the time window.

15. The device of claim 10, wherein the processor is further configured to:
before sending the information associated with the selected plurality of available geo-fenced curbside locations to the mobile device of the commercial vehicle operator:
adjust a first size of the first geo-fence boundary based on an indication of a demand of the particular curbside location for a particular time period; and
update the information with the adjusted first size of the first geo-fence boundary.

16. The device of claim 10, wherein the processor is further configured to:
send a message including a direction to the mobile device of the commercial vehicle operator, wherein the direction is to the reserved curbside location.

17. The device of claim 10, wherein the information associated with each of the plurality of available geo-fenced curbside locations includes a price per use or a price per unit of time for using the available geo-fenced curbside locations.

18. A mobile device comprising:
a transceiver configured to send and receive information from a service provider device; and
a processor configured to:
based on respective determined travel times, receive information associated with a plurality of available geo-fenced curbside locations from a current location of the mobile device including a travel time to respective curbside locations;
detect a selection of one of the available geo-fenced curbside locations;
send information about the detected selection of one of the available geo-fenced curbside locations; and
send geo-based information to the service provider device in response to detecting the mobile device crossing a first geo-fence boundary of the selected, available geo-fenced curbside location within a pre-determined time after sending the information about the detected selection of the available geo-fenced curbside location.

19. The mobile device of claim 18, wherein the processor is further configured to:
after detecting that the first geo-fence boundary is crossed, determine a dwell time duration of the mobile device until the mobile device exits the first geo-fence boundary; and
send information about the determined dwell time duration to the service provider device.

20. The device of claim 10, wherein the processor is further configured to:
before receiving information associated with the plurality of available geo-fenced curbside locations, providing a current geo-based location to the service provider device.
